(19) United States
(12) Patent Application Publication
(10) Pub. No.: US 2017/0303742 A1
(43) Pub. Date: Oct. 26, 2017

(54) Container for Heating Tortillas in a Toaster

(71) Applicant: Rudy Hayashi Gallego II, II, Knightsen, CA (US)

(72) Inventor: Rudy Hayashi Gallego II, II, Knightsen, CA (US)

(21) Appl. No.: 15/582,576

(22) Filed: Apr. 28, 2017

Related U.S. Application Data
(60) Provisional application No. 62/326,817, filed on Apr. 24, 2016.

(51) Int. Cl. A47J 37/08

(52) U.S. Cl. CPC A47J 37/0871; A47J 37/0885; A47J 37/0857; B65D 2581/3401

(57) ABSTRACT

A container for heating tortillas, quesadillas, pitas, or similar food articles in a toaster. The food articles have a moisture content by weight ranging from 30% to 52% prior to heating in the toaster. The container comprises an upright structure adapted to removably fit into the vertical slot of a conventional toaster and be supported by the toaster during a toaster heating cycle. The upright structure has a front and back connected to a hinged or metal ring bound bottom. The sides consist of a stainless-steel wire frame with vertical grate front and back which provides apertures for passing heat from the toaster to the food article located inside the container. The container is openable to permit removal of the food article after heating.

### FIELD OF THE INVENTION

The present invention relates to containers for supporting food articles heated in a toaster, and more particularly to such containers wherein foods articles are heated.

### BACKGROUND OF THE INVENTION

Tortillas, quesadillas, pitas, and/or similar food articles are some of the most popular convenience and staple foods. A wide variety of items are produced for restaurant and fast food service, as well as home use. Food articles are virtually universally served as a heated or toasted food article.

Four major advantages of the use of the container are:

1. It is very difficult to comparably heat or toast a food article using a microwave, convection, or conventional oven;

2. The container enables the user to heat or toast a food article, like tortillas, without the risk of folding or the risk of the food article sinking to the bottom of the toaster slot;

3. The time taken to heat or toast a food article given a toaster, with multiple upright slots and pairs of upright radiant heaters located at either side of each toaster slot, is considerably shorter;

4. Heating or toasting is made to be more uniform; and

5. The options of heating or caramelizing (turning brown) become more readily available. When the starches reach 310 degrees Fahrenheit they start to caramelize (turn brown). The air in the toaster readily reaches at least 310 degrees Fahrenheit. The heating elements themselves, generally, of nickel-chromium alloy, can reach 1100-1200 degrees Fahrenheit.

### OBJECTS OF THE INVENTION

It is an object of the present invention to provide toaster heated tortillas, pitas or similar food articles, tortillas and pitas comprising about 32% to about 55% moisture.

It is also another object of the present invention to provide a container for heating or toasting tortillas, pitas, or similar food articles in a toaster, which has apertures sized for sufficient open area but also sized to prevent tortillas, pitas or similar food article escaping from the container.

### SUMMARY OF THE INVENTION

In one aspect of the present invention, a container for heating tortillas, pitas or similar food article in a toaster comprises an upright structure adapted to removably fit into a vertical slot of a conventional toaster and be supported by the toaster during a toaster heating cycle. The upright structure has a front and back connected to a hinged or metal ring bound bottom. The sides consist of a stainless-steel wire frame with vertical grate front and back which provides apertures for passing heat from the toaster to the food article located inside the container. The container is openable to permit removal of the food article after heating.

As indicated in the BACKGROUND OF THE INVENTION above, the tortillas, pitas or similar food article are preferably oriented substantially upright and the container combined with how it fits into the toaster slot accommodates that.

The upright structure of the container is substantial and is of stainless steel construction. It is designed to have an extensive serviceable/useful life.

As indicated in the abstract above, the tortillas, pitas or similar food article have a moisture content ranging from 35% to 55% by weight prior to being heated in the toaster.

### DESCRIPTION OF THE DRAWINGS

Referring now to the drawings, on FIGS. 1 and 2, particularly FIG. 1, there is shown a first preferred embodiment of the present invention, which provides a container 15 for heating tortillas, pitas, or similar food articles in a toaster, indicated as 25. Container 15 has an upright structure comprising a front 17, a back 19, a top portion 23, a hinged bottom 27, side edges 20, hinges 29, handle 4 (handle-less models are contemplated by this application), and locking mechanism 6. Container is openable by unlocking lock mechanism 6 and separating front 17 from back 19. While opened front 17 and back 19 are held together by hinges 29.

The specification concludes with claims which particularly point out and distinctly claim the present invention, but it is believed that the present invention will be better understood from the following description of preferred embodiments, taken in conjunction with the accompanying drawings, in which like reference numerals identify identical elements and wherein:

FIG. 1 is perspective view of a toaster and a preferred embodiment of the present invention, showing a container for heating or toasting tortillas, quesadillas, pitas, and/or similar food articles with its top portion extending from the toaster slot;

FIG. 2 is a sectioned top elevation view of the container;

FIG. 3 is a front/back perspective view of the container for heating tortillas, quesadilla, pita or similar food article. Front and back both are of stainless steel wire mesh construction 8 which allows radiant heat from a conventional toaster to pass through into the container 15 to heat tortillas, quesadillas, pitas, and/or similar food articles inside container. A conventional toaster 25 typically has one or more upright slots 21 into which are placed items to be heated. On either side of each slot is a heating element (not shown) which may be heated to about 600.degree. F. At this temperature, infrared radiation is directed from the heating elements toward the item resting in each slot. The heating elements do not contact the items in the slots; therefore, radiation is believed to be the primary means of heat transfer. Heating continues for several minutes or until a sensor detects the desired temperature or discoloration of the heated item. The user generally is required to lift the heated item out of the toaster slot after the heat cycle is completed.

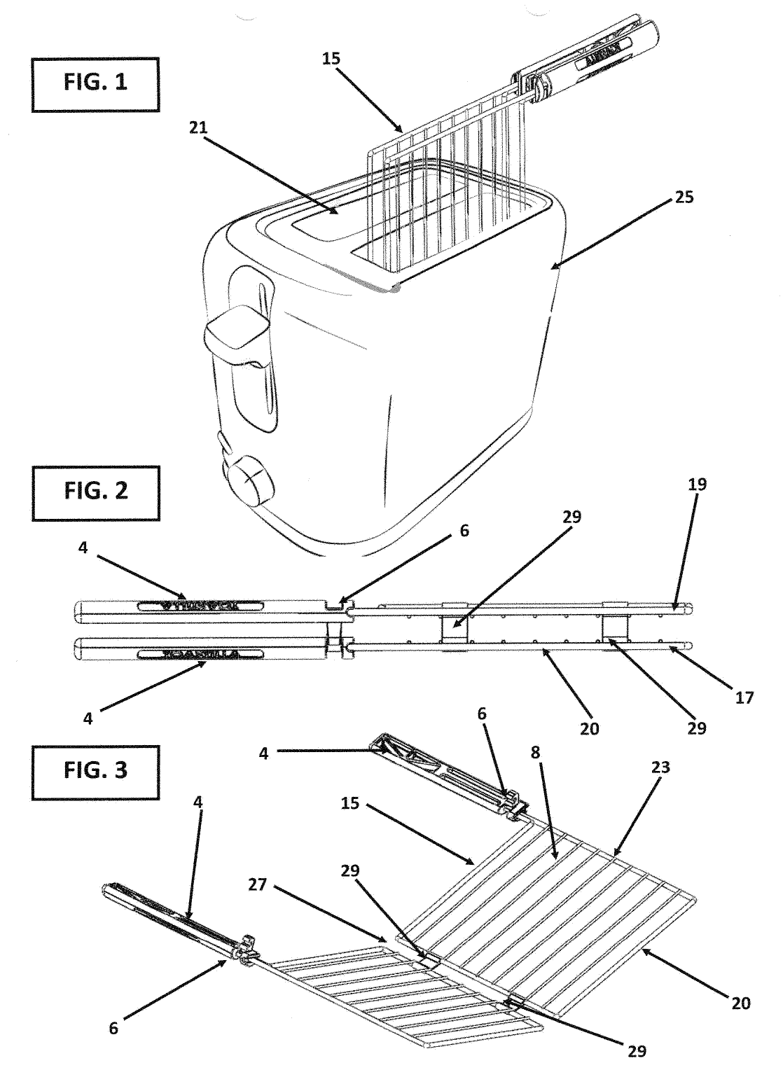

The stainless-steel wire frame with vertical grates 8 enables heat to enter at a rate which properly heats the tortillas, quesadillas, pitas, and/or similar food articles. The stainless-steel wire frame with vertical grates 8 also enables steam generated during the heating of tortillas, quesadillas, pitas, or similar food articles to escape from the tortillas, quesadillas, pitas, or similar food articles to outside of container 15. The sides of container 15 may alternatively be made from thin flexible stainless-steel metal stock stamped to create apertures through which radiant heat is allowed to flow; the sides of container 15 may alternatively be made from flexible silicone coated rubber stamped to create apertures through which radiant heat is allowed to flow;

Top portion 23 preferably extends well above the vertical slot 21 of a conventional toaster so that the extended portion is cool-to-the-touch during and after heating in the toaster. The stainless-steel wire mesh, flexible stainless-steel metal stock, or flexible silicone coated rubber provide limited conduction paths for heat between mesh screen wire, or apertures while allowing convection paths for air to cool the portion of the exposed container top 23. But since handle-less models are contemplated by this application, having a cool-to-the-touch portion of the container 15 enables the user to safely lift the container 15 and contents out of the toaster 25 using fingers. Utilizing the apertured top portion of the container for cool-to-the-touch handling eliminates the need for add-on handles or other more expensive solutions. For cool-to-the-touch effectiveness, the top portion preferably extends 1 to 2 inches (25 mm to 55 mm) above the toaster slot when the container is fully inserted into the slot.

A defective toaster may enable a current to pass through container 15 from toaster 25 and thereby potentially cause an electrical shock. Although such occurrence could be expected to be extremely rare based on known toaster safety records, top portion 23, and indeed entire container 15, may be coated externally with an electrically non-conductive material, such as silicon dioxide. Alternatively, an electrically non-conductive paper lifting tab may be attached to the container in place of top portion 23 in order to reduce container material as well as to reduce the potential for electrical shock.

Side edges 20 of container 15 have no adhesive holding them together because adhesive may melt or otherwise contaminate tortillas, quesadillas, pitas or similar food articles inside the container during heating. Other mechanical fastening techniques, other than hinges 29, may be used, such as perforating abutted side edges, spot welding them together, or combinations of these techniques.

The time for toasting tortillas, pitas or similar food article typically ranges from about 1.5 minutes to about 2.5 minutes. Overheating container 15 is not a problem, since it is made of stainless steel metal that does not melts unless temperature reaches above 1400° C. nearly triple the temperature of a conventional toaster.

While particular embodiments of the present invention have been illustrated and described, it will be obvious to those skilled in the art that various changes and modifications may be made without departing from the spirit and scope of the invention, and it is intended to cover in the appended claims all such modifications that are within the scope of the invention.

U.S. Patent Documents

| | | |
|---|---|---|
| 2,838,404 | June 1958 | Cohen |
| 2,881,078 | April 1959 | Oritt |
| 2,912,336 | November 1959 | Perino |
| 3,117,875 | January 1964 | Burns et al. |
| 3,185,372 | May 1965 | Ferraro |
| 3,361,576 | January 1968 | Jacobson |
| 3,392,033 | July 1968 | Thulin |
| 3,410,700 | November 1968 | Gstohl |
| 3,424,596 | January 1969 | Sullivan |
| 3,442,662 | May 1969 | Robinson |
| 3,446,632 | May 1969 | Le Van |
| 3,469,998 | September 1969 | Lane |
| 3,554,770 | January 1971 | Lipsky et al. |
| 3,585,048 | June 1971 | Uhlig et al. |
| 3,597,238 | August 1971 | Scharre |
| 3,615,706 | October 1971 | Robinson |
| 3,615,711 | October 1971 | Markus et al. |
| 3,633,239 | January 1972 | Rowe et al. |
| 3,672,916 | June 1972 | Virnig |
| 3,728,957 | April 1973 | Polus |
| 3,741,778 | June 1973 | Rowe |
| 3,759,721 | September 1973 | Hawley |
| 3,831,508 | August 1974 | Wallard |
| 3,836,064 | September 1974 | Stillwagon |
| 3,873,735 | March 1975 | Chalin et al. |
| 3,891,775 | June 1975 | Murray et al. |
| 4,051,266 | September 1977 | Goltsos |
| 4,135,004 | January 1979 | Finkel |
| 4,238,517 | December 1980 | Bosley et al. |
| 4,522,953 | June 1985 | Barby et al. |
| 4,603,052 | July 1986 | El-Hag et al. |
| 5,034,234 | July 1991 | Andreas et al. |
| 5,073,390 | December 1991 | Knight et al. |
| 5,096,723 | March 1992 | Turpin |
| 5,260,345 | November 1993 | Desmarais et al. |

Foreign Patent Documents

| | | |
|---|---|---|
| 797651 | October 1968 | CA |
| 797652 | October 1968 | CA |
| 869865 | May 1971 | CA |
| 1158988 | July 1969 | GB |

What is claimed is:

1. A container for heating food articles in a toaster; said container comprising an upright structure and tortillas, quesadillas, pitas and/or similar food article therein; said upright structure is adapted to removably fit into a vertical slot of a conventional toasters and be supported by said toaster during a toaster heating cycle; said upright structure having a front and back connected to a closed bottom; said upright structure has a front and back connected to a hinged or metal ring bound bottom. The sides consist of a stainless-steel wire frame with vertical grate front and back which provides apertures for passing heat from the toaster to the food article located inside the container; said container is openable to permit removal of the food article after heating; said container accommodates food article being oriented upright in said upright structure; said apertures being sized small enough that said food article cannot escape from said upright structure through said apertures.

2. The container of claim 1 wherein said tortillas, quesadillas, pitas, and/or similar food article have a moisture content ranging from 32% to 55% prior to heating in said toaster such that after heating, heated tortillas, quesadillas, pitas and/or similar food articles has substantially the same internal and surface texture as oven heated food articles.

3. The container of claim 1 wherein said upright structure is mechanically held together without adhesive such that mechanical fastening provides adequate strength for handling but is hinged so that said container is easy to open.

4. The container of claim 1 further comprising a handle portion extending above a toaster slot when said container is supported in said slot so that said handle portion is cool-to-the-touch during and after heating, and said handle is electrically non-conductive to reduce the potential for electrical shock when removing said container from said slot.

5. The container of claim 4 wherein said handle portion is a lifting handle attached to said container made of a heat-resistant phenolic or thermoplastic plastic.

6. The container of claim 5 wherein said handle portion is an extension of said container, said handle has an external coating of an electrically non-conductive material.
